(19) United States
(12) Patent Application Publication
(10) Pub. No.: US 2005/0083353 A1
(43) Pub. Date: Apr. 21, 2005

(54) Display device

(76) Inventors: Junichi Maruyama, Yokohama (JP); Hiroyuki Nitta, Fujisawa (JP)

Correspondence Address: MCDERMOTT WILL & EMERY LLP, 600 13TH STREET, N.W., WASHINGTON, DC, 20005-3096, US

(21) Appl. No.: 10/914,645

(22) Filed: Aug. 10, 2004

(30) Foreign Application Priority Data
Oct. 16, 2003 (JP) 2003-356487

(51) Int. Cl. G09G 3/36

(52) U.S. Cl. 345/690

(57) ABSTRACT

A correction circuit produces correction data, which is used to shorten a response time in a display panel, using first display data received from an external device and second display data stored in a frame memory, and appends the correction data to the first display data. The correction circuit includes: a detection information production circuit that detects based on first color information, second color information, and third color information, which is inferred from the response characteristic of the display panel and represents a change of a gray-scale level from one level to other, whether a color gap is produced during the change of a gray-scale level from one level to other; and a production circuit that when the detection information production circuit detects that a color gap is produced during the change of a gray-scale level from one level to other, produces correction data for the purpose of preventing production of the color gap.

### BACKGROUND OF THE INVENTION

1. Field of the Invention

The present invention relates to a display device on which an image (pixels) is displayed. More particularly, the present invention is concerned with a display device including a correction circuit that shortens a response time or a time while brightness in a liquid crystal changes.

2. Description of the Related Art

In general, what is referred to as the response time of a liquid crystal is a time from the instant a gray-scale voltage is applied to the liquid crystal to the instant desired brightness is attained. Moreover, the response characteristic of the liquid crystal depends on a start gray-scale voltage corresponding to an unchanged gray-scale level and a target gray-scale voltage corresponding to a changed gray-scale level. The response time therefore varies depending on the combination of the unchanged and changed gray-scale levels.

Each of pixels arranged in a liquid crystal display on which an image can be displayed in colors comprises sub-pixels of red, green, and blue, that is, elementary colors. Moreover, red, green, and blue gray-scale levels are each represented by display data but are not always identical to one another. Accordingly, gray-scale voltages to be applied to the red, green, and blue sub-pixels respectively are not always identical to one another.

Namely, as far as color display is concerned, response times at the red, green, and blue sub-pixels are not always identical to one another. Consequently, while a start gray-scale level changes to a target gray-scale level, an unexpected change of hues (color gap) is discerned.

As a technique for controlling production of the color gap, a means for applying a supply voltage through a switch is known as disclosed in, for example, U.S. Pat. No. 2003/6949 (JP-A-2003-29713). The means is included in an overdrive controller that drives a liquid crystal display, and comprises: a change rate Rst calculation unit that grasps the transition from current brightness to target brightness occurring at each of red, green, and blue sub-pixels; a selection unit that selects a sub-pixel at which the slowest transition among all the grasped transitions occurs, and other sub-pixels; an overdrive voltage calculation unit that calculates a voltage to be applied to the sub-pixel, at which the slowest transition has occurred, in order to accelerate the slowest transition of brightness; and an effective brightness Yst′ calculation unit and a Yst′ overdrive voltage calculation unit that calculate voltages to be applied to the other selected sub-pixels in order to accelerate or decelerate the transitions of brightness at the other sub-pixels so that the transitions will be made in harmony.

### SUMMARY OF THE INVENTION

According to the foregoing related art, production of a color gap can be suppressed. However, since the response times at the other two sub-pixels are degraded to agree with the response time at the sub-pixel at which the slowest response is made, the response times are hardly shortened.

An object of the present invention is to provide a display device on which a high-quality motion picture can be displayed by shortening a response time as much as possible while suppressing production of a color gap.

In order to solve the above problems, the present invention provides a display device comprising a frame memory in which first display data received from an external device is stored, and a correction circuit that appends correction data, which is used to shorten a response time in a display panel, to the first display data of a current frame according to the first display data and second display data (of an immediately preceding frame) which lags from the first display data stored in the frame memory by one frame period.

Moreover, a production circuit is included. The production circuit produces third correction data as the correction data by switching first correction data that is manipulated in order to prevent production of a color gap, and second correction data that is manipulated in order to shorten a response time as much as possible, or by performing arithmetic or logic operations.

Moreover, for switching the correction data, a detecting circuit that detects whether a color gap is produced in the course of changing brightness (gray-scale levels). If the detection circuit detects that a color gap may be produced in the course of changing brightness (gray-scale levels), the first correction data is selected in order to prevent production of the color gap. If the detection circuit detects that no color gap will be produced, the second correction data is selected in order to shorten the response time as much as possible.

Furthermore, in order to help the detection circuit detects whether a color gap is produced, a first color information production circuit, a second color information production circuit, and a third color information production circuit are included. The first color information production circuit samples color information on changed brightness (gray-scale level). The second color information production circuit samples color information on unchanged brightness (gray-scale level). The third color information production circuit samples color information on changing brightness inferred from the response characteristic of the display panel. Whether a color gap may be produced in the course of changing brightness (gray-scale levels) is detected from the relationship among the three pieces of color information.

As mentioned above, according to the present invention, both suppression of production of a color gap on the display device and improvement of the response speed of the display device can be achieved in a well-balanced manner. A motion picture can be displayed with high quality.

### BRIEF DESCRIPTION OF THE DRAWINGS

FIG. 1A and FIG. 1B are graphs indicating an example of a response to a change of brightness to be made in a liquid crystal;

FIG. 2 is a graph indicating an example of the responses to a change of brightness made at red, green, and blue sub-pixels constituting each pixel in a liquid crystal display panel;

FIG. 3 is a graph indicating an example of the responses to a change of brightness made at the red, green, and blue sub-pixels constituting each pixel in the liquid crystal display panel;

FIG. 4 is a graph indicating an example of a change of colors deriving from the response to a change of brightness at each of the red, green, and blue sub-pixels constituting each pixel in the liquid crystal display panel;

FIG. 5 shows an example of the configuration of a liquid crystal display device;

FIG. 6 shows an example of a table to be used to determine first correction data on the basis of a start gray-scale level and a reaching gray-scale level;

FIG. 7 shows an example of a table to be used to determine second correction data on the basis of a start gray-scale level and a reaching gray-scale level;

FIG. 8 shows an example of a table to be used to determine a response time on the basis of a start gray-scale level and a reaching gray-scale level;

FIG. 9 shows an example of a change of colors deriving from the response to a change of brightness caused by respective changes of gray-scale levels at the red, green, and blue sub-pixels constituting each pixel in the liquid crystal display panel;

FIG. 10 shows another example of a change of colors deriving from the response to a change of brightness caused by respective changes of gray-scale levels at the red, green, and blue sub-pixels constituting each pixel in the liquid crystal display panel;

FIG. 11 shows still another example of a change of colors deriving from the response to a change of brightness at the red, green, and blue sub-pixels constituting each pixel in the liquid crystal display panel;

FIG. 12 shows an example of a table to be used to determine a color gap permissible range on the basis of a start gray-scale level of each color and a reaching gray-scale level thereof;

FIG. 13 shows an example of the configuration of a liquid crystal display device;

FIG. 14 shows an example of a table to be used to detect based on a start gray-scale level and a reaching gray-scale level whether brightness reaches a target value within a predetermined time;

FIG. 15 shows an example of the response to a change of brightness caused by respective changes of gray-scale levels at the red, green, and blue sub-pixels constituting each pixel in the liquid crystal display panel; and

FIG. 16 shows an example of a change of colors deriving from the response to a change of brightness caused by respective changes of gray-scale levels at the red, green, and blue sub-pixels constituting each pixel in the liquid crystal display panel.

### DESCRIPTION OF THE PREFERRED EMBODIMENTS

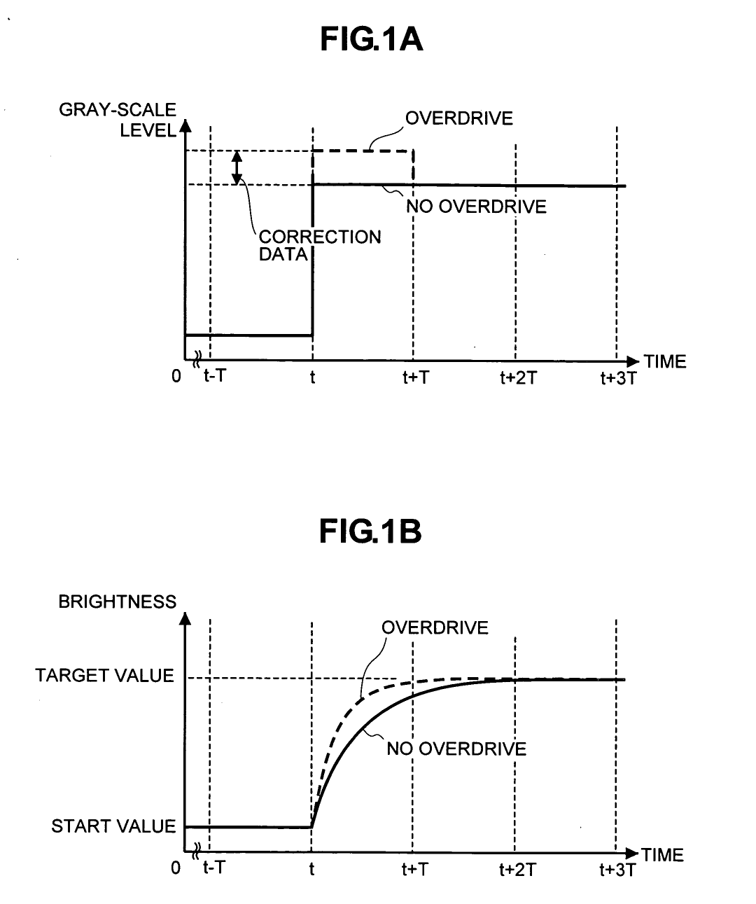

Referring to the drawings, an embodiment of the present invention will be described below. To begin with, overdrive for improving the response speed at which a liquid crystal display panel responds to a change of brightness will be described in conjunction with FIG. 1.

FIG. 1A and FIG. 1B are graphs indicating an example of a response to a change of brightness, which occurs when a gray-scale level to be received by a liquid crystal display panel is changed from one level to other level, made in the liquid crystal display panel. FIG. 1A indicates a change of a gray-scale level to be received by the liquid crystal display panel from one level to other level. The axis of ordinates indicates a gray-scale level, and the axis of abscissas indicates a time. Whether the gray-scale level is high or low depends on whether a voltage applied to the liquid crystal display panel is high or low. FIG. 1B shows the response to a change of brightness made in the liquid crystal display panel. The axis of ordinates indicates brightness attained in the liquid crystal display panel, and the axis of abscissas indicates a time. In FIG. 1A and FIG. 1B, a solid line indicates a case where overdrive is not implemented and a dashed line indicates a case where overdrive is implemented.

To begin with, the case where overdrive is not implemented will be described below.

In the example shown in FIG. 1A and FIG. 1B, at a time instant t, a gray-scale voltage to be applied to the liquid crystal display panel is varied stepwise. Consequently, the brightness attained in the liquid crystal display panel changes from a start value to a target value. T on the axis of abscissas denotes one frame period. What is referred to as one frame period is a cycle at intervals of which display data to be written at each pixel in the liquid crystal display panel is updated, that is, a cycle at intervals of which voltages to be applied to the liquid crystal are updated. In this case, the brightness must reach the target value within one frame period T for the purpose of preventing data, which represents a preceding frame displayed during a preceding frame period (time instant t-T), from causing an afterimage to remain within the succeeding (current) frame (time instant t). However, if a response to the change of brightness is unsatisfactorily made in the liquid crystal display panel, it takes a time much longer than one frame period T to reach the target value.

One of methods for solving the above problem is a technology called overdrive. A response time in a liquid crystal display panel depends on a start gray-scale voltage corresponding to an unchanged gray-scale level and a target gray-scale voltage corresponding to a changed gray-scale level. According to the overdrive technology, when a gray-scale level changes from a low level to a high level, a voltage higher than a target gray-scale voltage is applied in order to control a response speed at which a response is made in the liquid crystal. When the gray-scale level changes from the high level to the low level, a lower voltage is applied in order to control the response speed. Consequently, the response time in the liquid crystal is confined to one frame period or shorter.

To be more specific, as indicated with the dashed line in FIG. 1A, correction data is appended to display data to be written at a pixel at which the contents of display have changed. Thus, a gray-scale voltage to be applied to the pixel at which the contents of display have changed is improved in order to shorten the response time at the pixel in the liquid crystal. Consequently, as indicated with the dashed line in FIG. 1B, the response to the change of brightness to be made in the liquid crystal display panel is accelerated and completed within one frame period.

Herein, overdrive is implemented by appending correction data according to, for example, the expression (1) below.
D'c=Dc+Do (1)
where Dc denotes current frame data, Do denotes correction data, and D'c denotes corrected current frame data.

Moreover, correction data is calculated as a correction data calculation function or a function of current frame data and preceding frame data according to the expression (2) below.
Do=f(Dc, Dp) (2)
where Dp denotes preceding frame data.

The correction data calculation function provided by the expression (2) may be retrieved from a correction data calculation table using, for example, a start gray-scale level and a target gray-scale level as indices. The correction data calculation table is a table listing correction data that are adjusted so that a response to a change of brightness in the liquid crystal display panel caused by a change from every start gray-scale level to every target gray-scale level will be completed within one frame period.

Otherwise, the correction data calculation function may be determined according to the expression (3) below.
Do=f(Dc, Dp)=α×(Dc−Dp) (3)
where α denotes a correction data calculation coefficient. The correction data calculation coefficient α is determined so that a response to a change of brightness in the liquid crystal display panel caused by, for example, a change from every start gray-scale level to every target gray-scale level will be completed within one frame period. Moreover, a plurality of correction data calculation coefficients may be made available so that an optimal correction data calculation coefficient can be selected for each combination of the start gray-scale level and target gray-scale level.

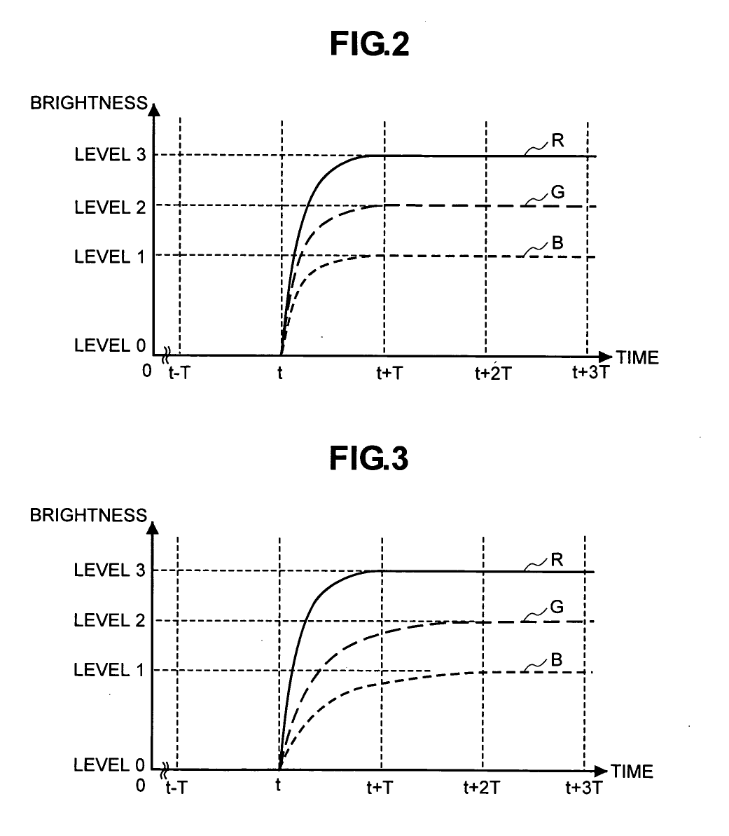

Next, a color gap to be produced while a transient response is being made in a liquid crystal display will be described in conjunction with FIG. 2 to FIG. 4. Each pixel in the liquid crystal display shall comprise red, green, and blue sub-pixels.

FIG. 2 is a graph indicating an example of a change of brightness which is derived from variations of gray-scale voltages to be applied to red, green, and blue sub-pixels and which is unaccompanied by production of a color gap. Herein, the gray-scale voltage to be applied to the red sub-pixel is varied in order to change the gray-scale level of red from level 0 to level 3, the gray-scale voltage to be applied to the green sub-pixel is varied in order to change the gray-scale level of green from level 0 to level 2, and the gray-scale voltage to be applied to the blue sub-pixel is varied in order to change the gray-scale level of blue from level 0 to level 1. Specifically, black is changed to a flesh color.

Ideally, the gray-scale levels at the red, green, and blue sub-pixels respectively reach the target levels during certain response times within one frame period. If the responses are made this way, when a start color changes to a target color, a color gap or a discernible unnatural color of different hues will not be produced.

FIG. 3 shows an example of a change of brightness which is derived from variations of gray-scale voltages to be applied to the red, green, and blue sub-pixels and which is accompanied by production of a color gap. Similarly to the case shown in FIG. 2, the gray-scale voltage to be applied to the red sub-pixel is varied in order to change the gray-scale level of red from level 0 to level 3, the gray-scale voltage to be applied to the green sub-pixel is varied in order to change the gray-scale level of green from level 0 to level 2, and the gray-scale voltage to be applied to the blue sub-pixel is varied in order to change the gray-scale level of blue from level 0 to level 1. However, the response times at the green and blue sub-pixels are longer than the response times at the red sub-pixel.

When the response times at the red, green, and blue sub-pixels are different from one another, a color gap is produced, that is, an unnatural color is discerned during a change of colors. Even in this case, similarly to the case described in conjunction with FIG. 2, black is changed to a flesh color. However, reddish blown is perceived in due course.

The foregoing examples will be described from other viewpoints. When hues are dealt with, if red, green, and blue signals are handled in the form of other color-space signals, it would be better than they are handled as they are. Herein, what are referred to as other color-space signals are, for example, Y, U, and V signals. The Y signal refers to a brightness signal (brightness component) representing brightness. The U and V signals refer to chrominance signals representing hues as color components. The U and V signals can be used to produce information on hues. The Y, U, and V signals are produced by converting the red, green, and blue signals according to the expressions (4) to (6) below. Otherwise, signals called YCbCr and YPbPr signals may be adopted. Even in this case, the same results will be attained, though expressions employed are a bit different from the expressions (4) to (6).
Y=0.299×R+0.587×G+0.114×B (4)
U=−0.169×R−0.331×G+0.500×B (5)
V=0.500×R−0.419×G+0.081×B (6)

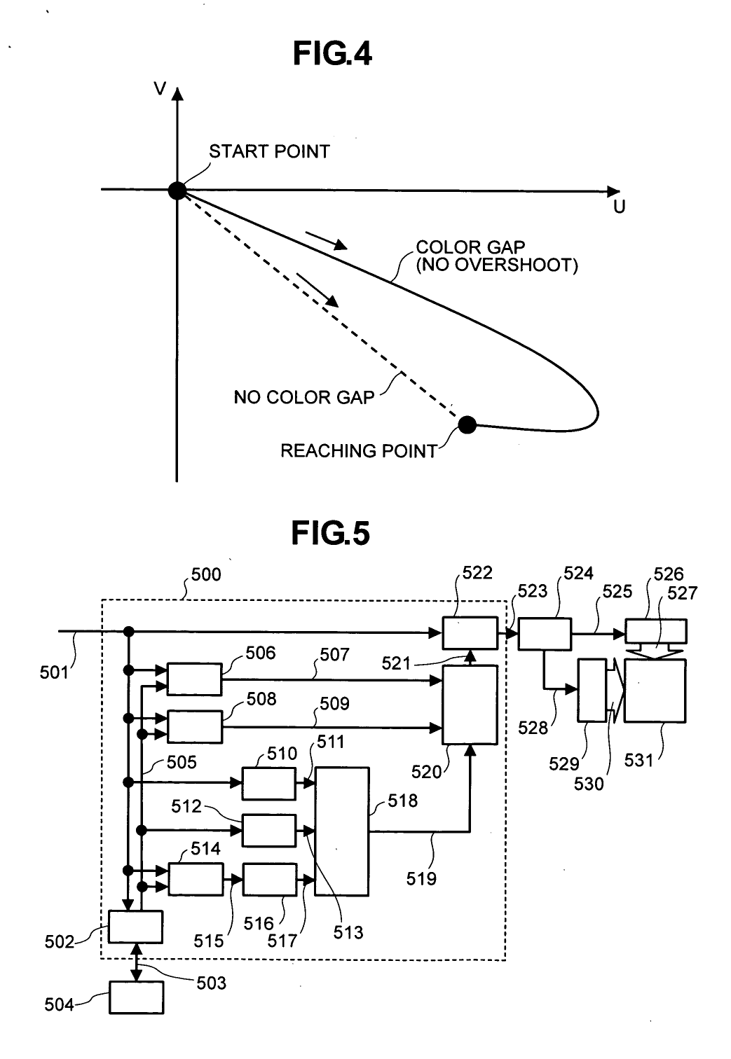

FIG. 4 shows an example of the variations of Y, U, and V signals accompanied or unaccompanied by production of a color gap. The axis of abscissas indicates the U signal, and the axis of ordinates indicates the V signal. Red, green, and blue signals that vary as indicated in FIG. 2 or FIG. 3 are converted into Y, U, and V signals. The variations of the U and V signals except the Y signal are plotted.

In FIG. 4, a start point refers to a point indicating the gray-scale levels that are represented by the red, green, and blue signals and that have not yet started changing. For example, the start point indicates the red, green, and blue gray-scale levels exhibited by an immediately preceding frame. A reaching point refers to a point indicating the gray-scale levels that are represented by the red, green, and blue signals and that have reached target levels (gray-scale levels represented by uncorrected input display data). For example, the reaching point indicates the red, green, and blue gray-scale levels exhibited by a current frame. As a liquid crystal display responds to a change of brightness, a display color changes from the one indicated by the start point to the one indicated by the reaching point. At this time, similarly to the case shown in FIG. 2, if the response times at the red, green, and blue sub-pixels are nearly identical to one another, the locus of points starting with the start point and ending with the reaching point will be a nearly straight line.

On the other hand, similarly to the case shown in FIG. 3, if the response times at the red, green, and blue sub-pixels are different from one another, the locus of points starting with the start point and ending with the reaching point will not a straight line but a largely curved line. When it says that the locus is largely curved, it means that hues largely change during a transient response. In other words, a color gap is produced.

As mentioned above, when the Y, U, and V signals are employed, production of a color gap in the three-dimensional space in which the red, green, and blue signals are defined can be expressed two-dimensionally in a plane in which the U and V signals are defined. Whether a color gap is produced during a change of colors can be judged easily. Moreover, there is the merit that an amount of data required for arithmetic operations is reduced. Since the gray-scale levels to be displayed at red, green, and blue sub-pixels respectively vary depending on display data, gray-scale voltages to be applied to the red, green, and blue sub-pixels respectively vary depending on display data.

In addition, the response characteristic of a liquid crystal depends on a start gray-scale voltage corresponding to an unchanged gray-scale level and a target gray-scale voltage corresponding to a changed gray-scale level. Namely, in general, the response time at each of the sub-pixels varies depending on the combination of the unchanged and changed gray-scale levels. Specifically, if the gray-scale voltages to be applied to the red, green, and blue sub-pixels respectively are controlled independently of one another, it is hard to agree the response times with one another. Consequently, a color gap is produced.

As mentioned above, as far as a liquid crystal display device is concerned, the response times at the red, green, and blue sub-pixels respectively should be agreed with one another in order to control production of a color gap during a transient response. Moreover, whether a color gap is produced can be judged from variations of Y, U, and V signals.

Next, an example of a method of agreeing the response times at red, green, and blue sub-pixels respectively with one another will be described below. For example, once the response times to respond to respective changes of all sets of gray-scale levels from one levels to other levels are agreed with one another, the response times at the red, green, and blue sub-pixels respectively agree with each other. Production of a color gap can be prevented. In order to agree the response times, which responds to respective changes of all sets of gray-scale levels from one levels to other levels, with one another, the response speed at which a response is made to a change of each gray-scale level from one level to other level should be increased or decreased. This can be achieved by programming overdrive so that an appropriate correction voltage will be applied.

However, even when the overdrive technology is implemented, there are limitations in shortening a response time due to restrictions including the property of a liquid crystal material. In order to agree response times with one another, the response times to respond to respective changes of all sets of gray-scale levels from one levels to other levels are agreed with the longest response times to respond to the slowest changes of red, green, and blue gray-scale levels from one levels to other levels.

What are referred to as the longest response times to respond to the slowest changes of red, green, and blue gray-scale levels from one levels to other levels are, for example, the response times that cannot be appropriately controlled according to the overdrive technology. Namely, depending on what is the highest voltage a circuit for applying a gray-scale voltage to a liquid crystal display panel can withstand, an upper limit of applicable gray-scale voltages may be determined. Otherwise, because of the configuration of the circuit, a certain range of voltages may not be able to be applied as a gray-scale voltage to a liquid crystal display panel.

In the above case, for example, assuming that a target gray-scale level is associated with a gray-scale voltage close to the upper or lower limit of a range of usable gray-scale voltages, if the gray-scale voltage is corrected in order to appropriately implement overdrive, the corrected gray-scale voltage may exceed the range of usable gray-scale voltages. In this case, overdrive cannot be implemented appropriately. Consequently, compared with when overdrive can be implemented appropriately, a response time gets longer.

An example of a method of agreeing the response times at red, green, and blue sub-pixels with one another has been described so far. The method in which the response times to respond to respective changes of all sets of gray-scale levels from one levels to other levels are agreed with the longest response times to respond to the slowest changes of red, green, and blue gray-scale levels from one levels to other levels for the purpose of preventing production of a color gap has drawbacks.

For example, assuming that the longest response times to respond to the slowest changes of red, green, and blue gray-scale levels from one levels to other levels are longer than one frame period, if overdrive is implemented based on the response times, production of an afterimage cannot be prevented because the response times to respond to respective changes of all sets of gray-scale level from one levels to other levels are longer than one frame period. Consequently, when a motion picture is displayed, the image quality is terribly degraded. There is therefore a demand for a method of preventing production of a color gap and avoiding degradation of image quality attributable to production of an afterimage.

Next, the method will be described. A combination of changed and unchanged colors may be a combination of colors whose change does not cause production of a color gap even if a response time to respond to the change is shortened, or a combination of colors whose change causes production of a color gap whose degree is so small that the color gap is indiscernible. For the combination of colors, overdrive need not be implemented in order to agree response times with the longest response times to respond to the slowest changes of red, green, and blue gray-scale levels respectively to other levels. Overdrive may be implemented in order to further shorten the response times. When the response times are shortened, an afterimage produced during display of a motion picture is alleviated. This leads to improved image quality.

The response times to respond to respective changes of red, green, and blue gray-scale levels from one levels to other levels are shortened by adjusting a correction value needed to implement overdrive and applying appropriate gray-scale voltages. By the way, no color gap is produced in a case where, for example, gray-scale voltages to be applied to red, green, and blue sub-pixels are varied from those corresponding to the same start gray-scale level to those corresponding to the same reaching gray-scale level. In this case, the response times at the sub-pixels are identical to one another. No color gap is produced despite correction based on the overdrive technology is performed.

As mentioned above, whether a color gap is produced in the course of changing gray-scale levels is detected. A correction value used to implement overdrive is adjusted based on the result of detection, whereby production of a color gap is prevented and degradation of image quality attributable to production of an afterimage is avoided.

Next, a method of checking whether a color gap is produced will be described below. As the method of checking whether a color gap is produced, a method of judging from Y, U, and V signals whether a color gap is produced is adopted. Namely, red, green, and blue signals are converted into Y, U, and V signals. A locus of points that start with a start point on a UV plane and end with a reaching point thereon and that indicate a change in display data is checked to see if the locus is largely separated from a straight line linking the start point and reaching point.

To be more specific, the distance of each point on the locus from the straight line is calculated, and whether the distance is larger or smaller than a predetermined value is detected. If the distance is larger than the predetermined value, a color gap is detected to be produced. If the distance is smaller, no color gap is detected to be produced. If no color gap is detected to be produced, display data is corrected through overdrive so that response times will be shortened as much as possible. On the other hand, if a color gap is detected to be produced, display data is corrected through overdrive so that no color gap will be produced.

The method of implementing overdrive so as to shorten response times as much as possible while preventing production of a color gap has been described so far. When this method is adopted, both suppression of a color gap and suppression of a blur caused by an afterimage can be achieved. When a motion picture is displayed on a liquid crystal display device, higher image quality can be provided.

Next, a liquid crystal display device including a mechanism for implementing overdrive will be described below.

FIG. 5 is a block diagram showing an example of the configuration of a liquid crystal display device to which the present invention is adapted. There are shown: a data correction circuit (overdrive circuit) 500 that implements overdrive; a bus 501 over which display data received from an external device and sync signals are transferred; a frame memory control circuit 502; a frame memory control bus 503; a frame memory 504; and a data bus 505 over which display data read from the frame memory is transferred.

A first addition/subtraction data production circuit 506 compares display data transferred over the data bus 501 with display data transferred over the data bus 505. Addition/subtraction data produced by the addition/subtraction data production circuit 506 is transferred over a data bus 507.

A second addition/subtraction data production circuit 508 compares display data transferred over the data bus 501 with display data transferred over the data bus 505. Addition/subtraction data produced by the addition/subtraction data production circuit 508 is transferred over a data bus 509.

A first color signal data production circuit 510 produces color signals according to display data transferred over the data bus 501. First color signal data produced by the first color signal data production circuit 510 is transferred over a data bus 511.

A second color signal data production circuit 512 produces color signals according to display data transferred over the data bus 505. Second color signal data produced by the second color signal data production circuit 512 is transferred over a data bus 513.

A response time data production circuit 514 compares display data transferred over the data bus 501 with display data transferred over the data bus 505. Response time data produced by the response time data production circuit 514 is transferred over a data bus 515.

A third color signal data production circuit 516 produces color signals according to the response time data transferred over the data bus 515. Third color signal data produced by the third color signal data production circuit 516 is transferred over a data bus 517.

A color gap detection data production circuit 518 compares color signal data transferred over the data bus 511 with color signal data transferred over the data bus 513 or data bus 517. Color gap detection data produced by the color gap detection data production circuit 518 is transferred over a data bus 519.

A third addition/subtraction data production circuit 520 produces third addition/subtraction data according to the first addition/subtraction data transferred over the data bus 507, the second addition/subtraction data transferred over the data bus 509, and the color gap detection data transferred over the data bus 519. Third addition/subtraction data produced by the third addition/subtraction data production circuit 520 is transferred over a data bus 521.

A data addition/subtraction circuit 522 converts display data transferred over the data bus 501 on the basis of third addition/subtraction data transferred over the data bus 521. Display data produced by the data addition/subtraction circuit 522 and control signals used to control timings, such as, sync signals are transferred over a bus 523.

A timing control circuit 524 produces various timing signals that are used to control timings for a liquid crystal drive circuit. Display data and sync signals produced by the timing control circuit 524 are transferred over a bus 525. The sync signals produced by the timing control circuit 524 are transferred to a scan line drive circuit 529 over a bus 528.

A signal line drive circuit 526 produces a gray-scale voltage according to display data transferred over the bus 525. A scan line drive circuit 529 sequentially selects a line to which the gray-scale voltage produced by the signal line drive circuit 526 is applied. A liquid crystal display panel 531 has a plurality of pixels arranged in the form of a matrix. The gray-scale voltage produced by the signal line drive circuit 526 is transferred to the liquid crystal display panel 531 over a drain wire bus 527. A scan voltage produced by the scan line drive circuit 529 is transferred to the liquid crystal display panel 531 over a gate wire bus 530.

In the liquid crystal display device in accordance with the present invention, display data and sync signals received from an external device over the data bus 501 are stored in the frame memory 504 via the frame memory control circuit 502 over the frame memory control bus 503.

The frame memory control circuit 502 sequentially reads display data from the frame memory 504 after the elapse of one frame period, and transmits the display data over the data bus 505. The frame memory control circuit 502 repeats this action involving the frame memory control bus 503 and frame memory 504.

Consequently, display data to be received by each of the first addition/subtraction data production circuit 506, second addition/subtraction data production circuit 508, second color signal data production circuit 512, and response time data production circuit 514 is transferred over the bus 505. The display data therefore lags behind display data, which is transferred over the data bus 501, by one frame period. In other words, display data of an immediately preceding frame is transferred over the bus 505. Thus, a change of a gray-scale level from one level to other exhibited by a pixel is calculated using two successive frame data.

Consequently, the first addition/subtraction data production circuit 506 judges whether display data makes a change over successive frame periods. If display data makes a change over successive frame periods, first addition/subtraction data serving as correction data to be transferred over the data bus 507 can be calculated based on the relationship between unchanged display data and changed display data.

For calculation of the first addition/subtraction data to be transferred over the data bus 507, a method described below may be adopted. For example, a table from which optimal first addition/subtraction data can be retrieved based on the combination of, for example, a start gray-scale level and a reaching gray-scale level is created in advance. The first addition/subtraction data is determined by referencing the table.

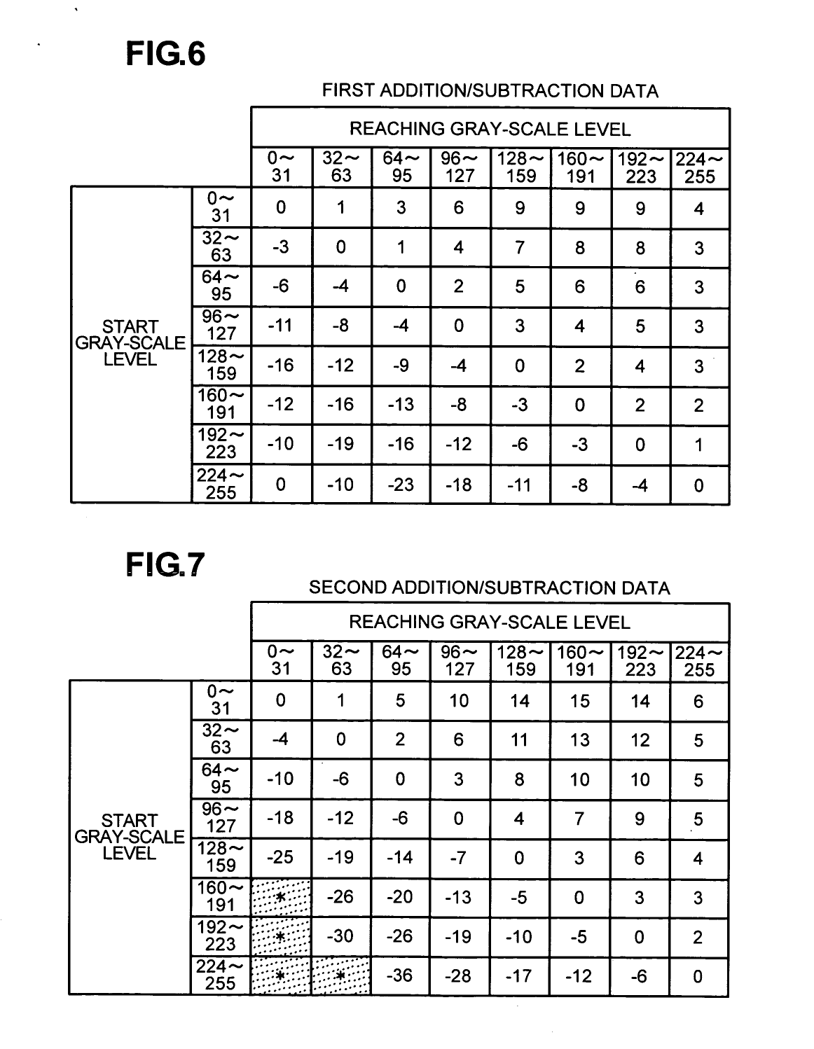

FIG. 6 shows an example of a first table from which the first addition/subtraction data is retrieved based on the combination of the start gray-scale level and reaching gray-scale level. The first table is a mere example that may be employed in a case where an in-plane switching (IPS)-mode liquid crystal display panel is adopted as the liquid crystal display panel 531. Once the values to be specified in the table in rows and columns are determined appropriately, the method employing the table can be adapted to any liquid crystal display panel of other mode. In the first table, the first addition/subtraction data is determined so that a response time will remain nearly constant relative to a change from every start gray-scale level to every reaching gray-scale level. Specifically, response times are agreed with the longest response time to respond to the slowest change from a start gray-scale level to a reaching gray-scale level.

Referring to FIG. 6, gray-scale levels to be handled range from level 0 to level 255, that is, the number of gray-scale levels to be handled is 256. The number of gray-scale levels may be set to any other value. Moreover, the 256 gray-scale levels are divided into eight blocks, and addition/subtraction data is associated with each block. The number of blocks is not limited to eight. Moreover, the number of gray-scale levels belonging to each block, that is, the size of each block is the same among all blocks. Alternatively, the sizes of blocks may be different from one another. For example, low and high gray-scale levels may be divided into a large number of blocks, but intermediate gray-scale levels may be divided into a small number of blocks.

Moreover, for example, the signal line drive circuit 526 associates a gray-scale level with a gray-scale voltage. The association is intended to adjust a gamma defining the relationship between red, green, and blue gray-scale levels transferred to the liquid crystal display device and brightness determined with the gray-scale levels. If the gamma characteristic of the liquid crystal display device is modified, the relationship between the gray-scale level and gray-scale voltage changes. Therefore, the values specified in the first table must be altered according to the modified gamma characteristic.

As for the first table shown in FIG. 6, the same table may be used for all the red, green, and blue signals or different tables may be used for the red, green, and blue signals respectively. Moreover, the first addition/subtraction data varies depending on the material made into the liquid crystal panel.

The method of calculating the first addition/subtraction data using a table has been described. Alternatively, addition/subtraction data may be calculated by performing arithmetic operations using a start gray-scale level, a reaching gray-scale level, and some predetermined parameters.

For example, the values specified in the first addition/subtraction data table may be approximated to a linear function or a quadratic function. In this case, preferably, the coefficients contained in the of the function can be externally designated as parameters (for example, using a CPU) and recorded in a register incorporated in a data addition/subtraction circuit. Thus, the table can be flexibly adapted to various types of liquid crystal display panels. Otherwise, the values specified in the first addition/subtraction data table may be fitted to a polygonal line composed of a plurality of segments and expressed with a function. In this case, preferably, the position at which segments intersect or the slope of each segment can be externally designated as a parameter. Thus, the table can be flexibly adapted to various types of liquid crystal display panels.

Moreover, preferably, the first table and the parameters employed in arithmetic operations can be externally designated using, for example, a storage device such as an EEPROM, an interface with a CPU, or an external terminal via which setting information is received.

Similarly, the second addition/subtraction data production circuit 508 can judge whether display data makes a change over successive frame periods. Furthermore, if display data makes a change over successive frame periods, second addition/subtraction data serving as correction data to be transferred over the data bus 509 can be calculated based on the relationship between unchanged display data and changed display data.

For the calculation of the second addition/subtraction data to be transferred over the data bus 509, a method described below may be adopted. For example, a table from which optimal second addition/subtraction data is retrieved based on the combination of a start gray-scale level and a reaching gray-scale level is created in advance. The table is referenced in order to determine the second addition/subtraction data is determined.

FIG. 7 shows an example of a second table to be referenced in order to retrieve the second addition/subtraction data on the basis of the combination of a start gray-scale level and a reaching gray-scale level. The table is an example to be employed in a case where an in-plane switching (IPS)-mode liquid crystal display panel is adopted as the liquid crystal display panel 531. The method using the table may be adapted to any liquid crystal display panel of other mode by appropriately determining the values specified in the table.

The second addition/subtraction data is determined so that a response time to respond to a change from every start gray-scale level to every reaching gray-scale level will be shorter than that resulting from correction based on the first addition/subtraction data, for example, so that a response time will be the shortest.

Referring to FIG. 7, an asterisk * signifies that a gray-scale voltage corrected for implementation of overdrive exceeds a range of usable gray-scale voltages. In this case, as mentioned above, the effect of overdrive cannot be appropriately provided. However, when a voltage value closest to the corrected gray-scale voltage within the range of usable gray-scale voltages is adopted, the effect of overdrive may be drawn out to some extent.

FIG. 7 shows an example to be employed in a case where the number of gray-scale levels to be handled is 256, that is, the gray-scale levels to be handled range from level 0 to level 255. Alternatively, the number of gray-scale levels may be any other value. Herein, the 256 gray-scale levels are divided into eight blocks, and addition/subtraction data is determined for each of the blocks. The number of blocks is not limited to eight. Moreover, the number of gray-scale levels belonging to each block, that is, the size of each block is the same among all blocks. Alternatively, the blocks may have different sizes. For example, low and high gray-scale levels may be divided into a large number of blocks, but intermediate gray-scale levels may be divided into a small number of blocks.

Moreover, for example, the signal line drive circuit 526 associates a gray-scale level with a gray-scale voltage. The association is intended to adjust a gamma defining the relationship between red, green, and blue gray-scale levels to be transferred to the liquid crystal display device and brightness determined with the gray-scale levels. If the gamma characteristic of the liquid crystal display device is modified, the relationship between the gray-scale level and gray-scale voltage changes. Therefore, the values specified on the second table must be appropriately altered according to the modified gamma characteristic.

As for the second table, the same table may be used for all the red, green, and blue signals or different tables may be used for the red, green, and blue signals respectively. Moreover, the second addition/subtraction data varies depending on the material made into the liquid crystal display panel.

Referring to FIG. 7, the method of calculating the second addition/subtraction data using the second table has been described above. Alternatively, for example, addition/subtraction data may be calculated by performing arithmetic operations using a start gray-scale level, a reaching gray-scale level, and some predetermined parameters.

For example, the values specified in the second addition/subtraction data table may be approximated to a linear function or a quadratic function. In this case, preferably, the coefficients contained in the terms of the function can be externally designated as parameters. Thus, the table can be flexibly adapted to various types of liquid crystal display panels. Alternatively, the values specified in the second addition/subtraction data table may be fitted to a polygonal line composed of a plurality of segments and expressed with a function. In this case, preferably, the position at which segments intersect or the slope of each segment can be externally designated as a parameter. Thus, the table can be flexibly adapted to various types of liquid crystal display panels.

Moreover, preferably, the second table and the parameters employed in arithmetic operations can be externally designated using, for example, a storage device such as an EEPROM, an interface with a CPU, or an external terminal via which setting information is received.

Similarly, the response time data production circuit 514 can judge whether display data makes a change over successive frame periods. If display data makes a change over successive frame periods, response time data to be transferred over the data bus 515 can be calculated based on the relationship between unchanged display data and changed display data.

What is referred to as response time data is data representing a time which the liquid crystal display panel requires to respond to a change from a start gray-scale level to a reaching gray-scale level in a case where overdrive is implemented based on the data retrieved from the second table according to the combination of the start gray-scale level and reaching gray-scale level.

For calculation of response time data to be transferred over the data bus 515, a method described below may be adopted. For example, a table from which a response time is retrieved based on the combination of a start gray-scale level and a reaching gray-scale level may be created in advance so that the table can be referenced in order to determine a response time.

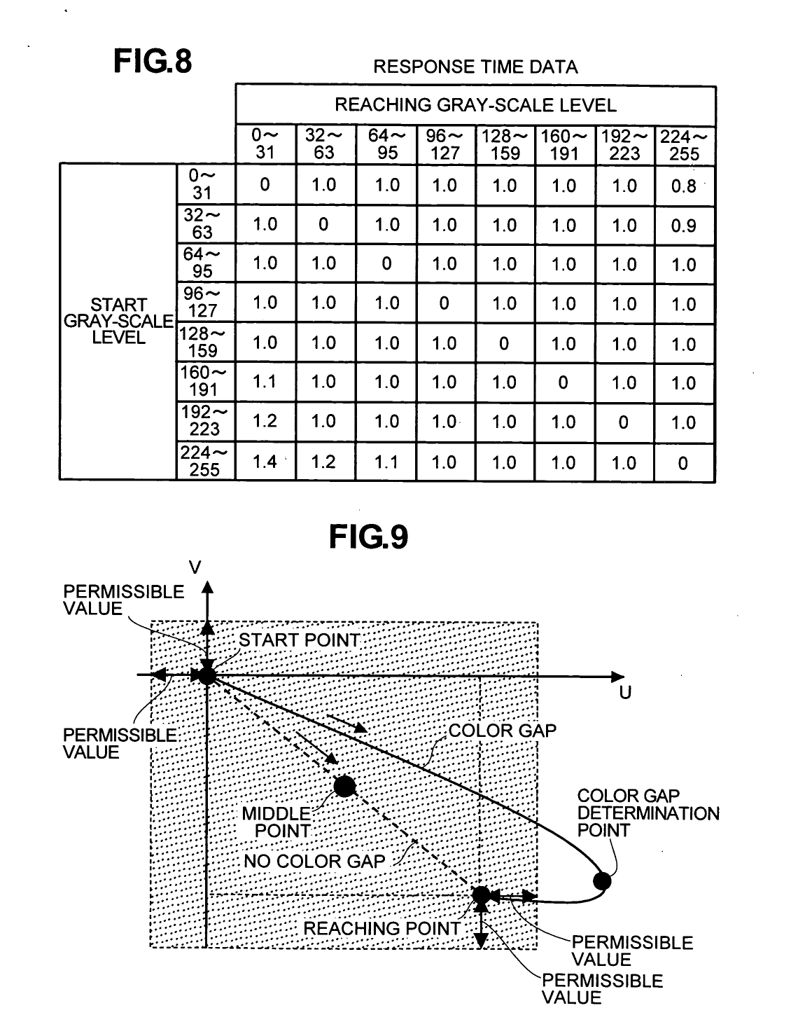

FIG. 8 shows an example of a third table from which a response time is retrieved based on the combination of a start gray-scale level and a reaching gray-scale level in a case where overdrive is implemented based on the second addition/subtraction data retrieved from the second table. Herein, the response time is indicated as a multiple of one frame period T.

The table shown in FIG. 8 is an example to be employed in a case where an in-plane switching (IPS)-mode liquid crystal display panel is adopted as the liquid crystal display panel 531. The table can be adapted to any liquid crystal display panel of other mode by appropriately determining the values specified in the table.

FIG. 8 shows an example to be employed in a case where gray-scale levels to be handled range from level 0 to level 255, that is, the number of gray-scale levels is 256. Alternatively, the number of gray-scale levels may be any other value. Herein, the 256 gray-scale levels are divided into eight blocks, and addition/subtraction data is determined for each of the blocks. The number of blocks is not limited to eight. Moreover, the number of gray-scale levels belonging to each block, that is, the size of each block is the same among all the blocks. Alternatively, the sizes of blocks may be different from one another. For example, low and high gray-scale levels may be divided into a large number of blocks, and intermediate gray-scale levels may be divided into a small number of blocks.

For example, the signal line drive circuit 526 associates a gray-scale level with a gray-scale voltage. The association is intended to adjust a gamma defining the relationship between red, green, and blue gray-scale levels to be transferred to the liquid crystal display device and brightness determined with the gray-scale levels. If the gamma characteristic of the liquid crystal display device is modified, the relationship between the gray-scale level and gray-scale voltage changes. Therefore, the values specified in the third table must be appropriately altered according to the modified gamma characteristic.

As for the third table, the same table may be used for all the red, green, and blue signals, or different tables may be used for the red, green, and blue signals respectively. Moreover, the response time data varies depending on a material made into the liquid crystal display panel.

Referring to FIG. 8, the method of calculating a response time using a table has been described. Alternatively, for example, a response time may be calculated by performing arithmetic operations using a start gray-scale level, a reaching gray-scale level, and some predetermined parameters. For example, the coefficient of viscosity or elasticity of a liquid crystal material to be made into the liquid crystal display panel, the thickness of a liquid crystal layer of each liquid crystal cell, and the anisotropy of a dielectric constant are used as parameters to calculate a response time.

Preferably, the third table and the parameters to be employed in arithmetic operations can be externally designated using, for example, a storage device such as an EEPROM, an interface with a CPU, or an external terminal via which setting information is received.

Referring back to FIG. 5, the first color signal data production circuit 510 produces color signals according to display data transferred over the data bus 501. In order to produce the first color signal data, for example, a circuit is included for performing the arithmetic operations provided as the expressions (4) to (6).

The second color signal data production circuit 512 produces color signals according to display data transferred over the data bus 505. In order to produce the second color signal data, for example, a circuit is included for performing the arithmetic operations provided as the expressions (4) to (6).

The third color signal data production circuit 516 produces color signals according to response time data transferred over the data bus 515. In order to produce the third color signal data, a circuit is included for calculating gray-scale levels represented by red, green, and blue signals at predetermined timings within a period from the instant brightness at a pixel starts changing from a start value to the instant the brightness reaches a target value. The gray-scale levels shall be called red, green, and blue transient gray-scale levels. Each of the red, green, and blue transient gray-scale levels can be calculated based on the relationship among the start brightness, the target brightness, the response time data, and the timing of calculating a transient gray-scale level.

The third color signal data production circuit 516 calculates transient levels of Y, U, and V signals using the red, green, and blue transient gray-scale levels. For calculation of the transient Y, U, and V signal levels, a circuit for performing arithmetic operations provided as the expressions (4) to (6) is included.

The color gap detection data production circuit 518 compares color signal data transferred over the data bus 511 with color signal data transferred over the data bus 513 or 517. Color gap detection data produced by the color gap detection data production circuit 518 is data indicating whether a color gap is discerned during a change of brightness. The color gap detection data can be calculated based on the relationship among a start point, a reaching point, and a color gap detection point defined in the aforesaid UV plane.

Next, an example of a method of identifying a color gap will be described in conjunction with FIG. 9. Similarly to FIG. 4, FIG. 9 shows the variations of the U and V color signals deriving from respective changes of gray-scale levels, which are represented by gray-scale voltages to be applied to red, green, and blue sub-pixels, deriving from a change in display data of a pixel concerned.

Referring to FIG. 9, a reaching point is calculated from first color signal data, and a start point is calculated from second color signal data. A color gap detection point is calculated from third color signal data. Whether a color gap is discerned during a change of brightness is detected by judging whether the color gap detection point in the UV plane shown in FIG. 9 falls within or outside a color gap permissible range determined based on the positional relationship between the start point and reaching point.

For example, if the color gap detection point falls within the color gap permissible range, that is, if the color gap detection point is located near a segment linking the start point and reaching point, a color gap is detected not to be produced. On the other hand, if the color gap detection point falls outside the color gap permissible range, that is, if the color gap detection point is located away from the segment linking the start point and reaching point, a color gap is detected to be produced.

What is referred to as the color gap permissible range is a range defined with a graphic containing the start point and reaching point, such as, a rectangle, a circle, an ellipse, or a parallelogram. At this time, the size of the graphic indicates a range of permissible values indicating the possibility of production of a color gap. Specifically, the larger the graphic is, or, the larger a permissible value is, the lower the possibility that production of a color gap may be detected is. In contrast, the smaller the permissible value, the higher the possibility.

FIG. 9 shows an example in which the color gap permissible range is defined with a rectangle drawn with a dot line. In this example, the sides of a rectangle having a start point and a reaching point as diagonal points are extended by a color gap permissible value in each of U-axis and V-axis directions. The inside of the resultant rectangle is defined as the color gap permissible range.

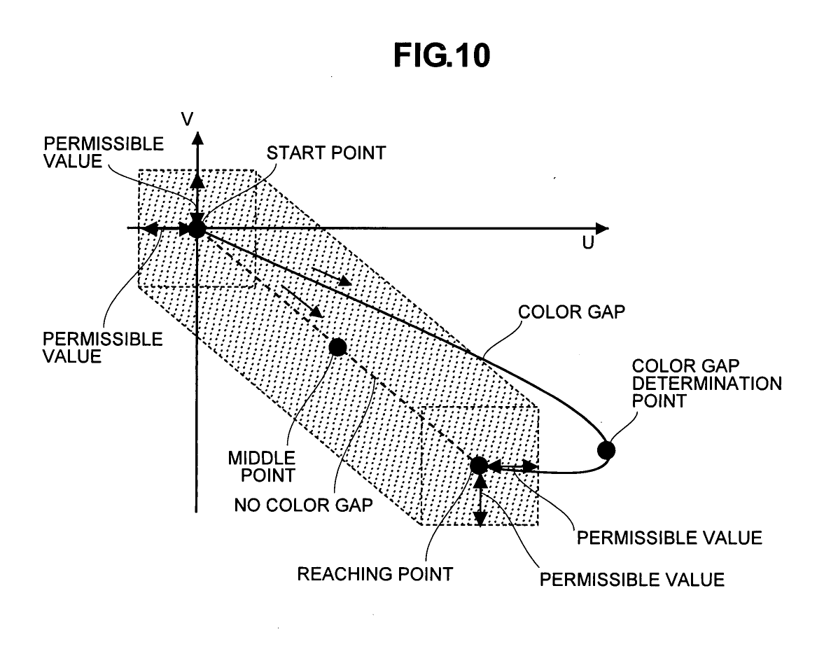

Moreover, FIG. 10 shows an example in which the color gap permissible range is defined with a graphic drawn by linking the vertexes of two squares having a start point or a reaching point in the centers of diagonals thereof. In this case, a permissible value is determined to correspond to a half of the length of one side of each square.

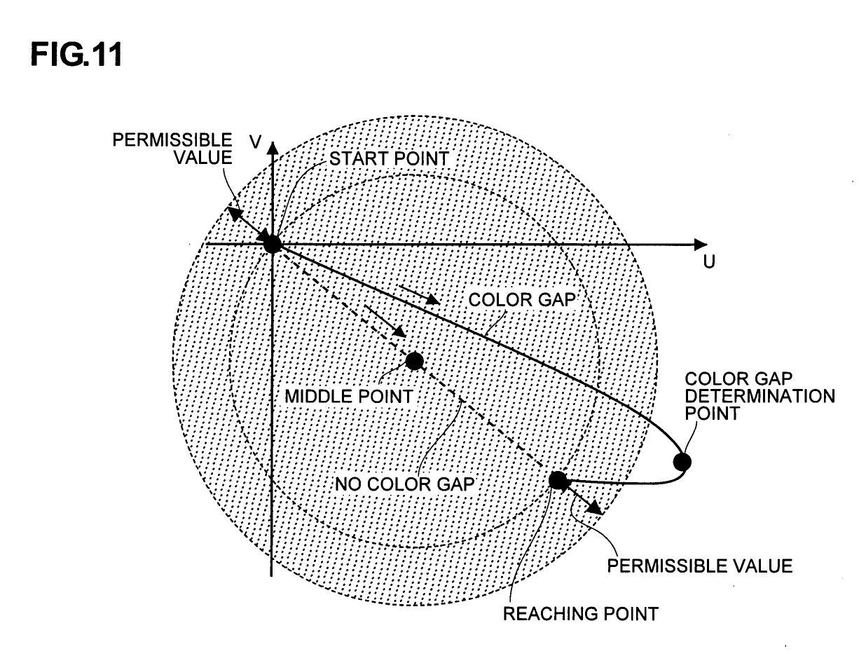

In an example shown in FIG. 11, the color gap permissible range is defined with a circle whose center is located at the middle point of a segment linking a start point and a reaching point and whose radius corresponds to the sum of a distance from the center to the start or reaching point and a permissible value. In this case, an ellipse may be substituted for the circle.

A color gap permissible value will be described. A resolution offered by a human vision varies depending on the frequency of light. Namely, a human being is sensitive to a change of a certain color but insensitive to a change of other color. A permissible value indicating the possibility of production of a color gap caused by a color whose change is quite discernible is set to a small value. A permissible value indicating the possibility of production of a color gap caused by a color whose change is indiscernible is set to a large value. Thus, the precision in detecting whether a color gap is produced can be improved optimally to the human vision. Needless to say, a permissible range may be defined in common among all colors.

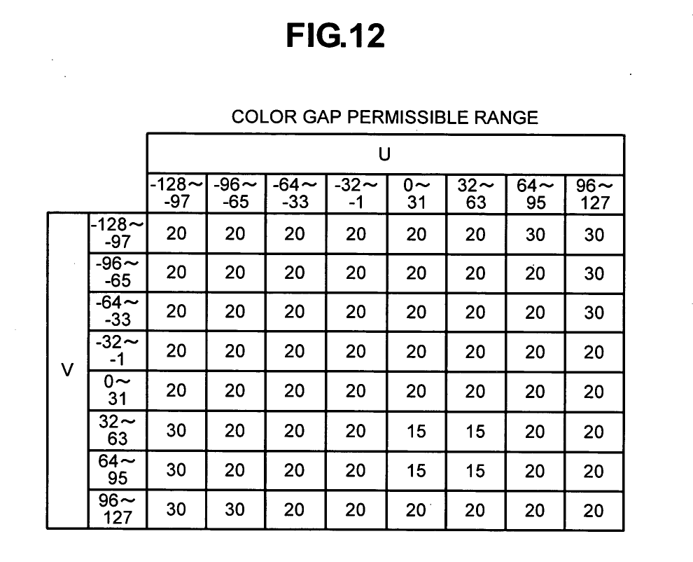

FIG. 12 shows an example of a permissible value table from which a permissible value is retrieved based on the combination of the U and V signals and which is employed in a case where a color gap permissible range is defined for each color. Referring to FIG. 12, a permissible value is provided as an index indicating the size of the color gap permissible range. For example, the larger the permissible value, the wider the permissible range. This signifies that production of a color gap is tolerated. On the other hand, the smaller the permissible value, the narrower the permissible range. This signifies that production of a color gap is readily discernible. A permissible value is retrieved based on the U and V signal values indicated by the start or reaching point. Thus, the permissible range is defined in an appropriate size.

For example, assume that the color gap permissible range is defined as shown in FIG. 9, FIG. 10, or FIG. 11. The table may be structured so that a permissible value can be retrieved based on coordinates representing the middle point of a segment linking a start point and a reaching point. Otherwise, the table may be structured so that a permissible value can be retrieved based on coordinates representing the start point or reaching point.

Moreover, preferably, the values specified in the permissible value table can be externally designated using, for example, a storage device such as an EEPROM, an interface with a CPU, or an external terminal via which setting information is received.

FIG. 12 shows an example to be employed in a case where the number of levels the U or V signals assumes is 256, that is, the levels the U or V signal assumes range from level -128 to level 127. The number of levels the U or V signal assumes may not be 256 but may be any other value. The 256 levels are divided into eight blocks, and a permissible range is determined for each of the blocks. The number of blocks is not limited to eight. Moreover, the number of levels belonging to each block, that is, the size of each block is the same among all the blocks. Alternatively, the sizes of the blocks may be different from one another.

Moreover, for example, the signal line drive circuit 526 associates a gray-scale level with a gray-scale voltage. The association is intended to adjust a gamma defining the relationship between red, green, and blue gray-scale levels received by the liquid crystal display device and brightness determined with the gray-scale levels. If the gamma characteristic of the liquid crystal display device is modified, the relationship between the gray-scale level and gray-scale voltage changes. Therefore, the values specified in the color gap permissible value table must be appropriately altered according to the modified gamma characteristic.

Referring back to FIG. 5, the third addition/subtraction data production circuit 520 produces third addition/subtraction data on the basis of first addition/subtraction data transferred over the data bus 507, second addition/subtraction data transferred over the data bus 509, and color gap detection data transferred over the data bus 519.

For example, if it is judged from color gap detection data that the use of second addition/subtraction data causes a color gap, first addition/subtraction data is selected and used as third addition/subtraction data relative to each of red, green, and blue signals. If the use of the second addition/subtraction data is judged not to cause a color gap, the second addition/subtraction data is selected and used as the third addition/subtraction data relative to each of the red, green, and blue signals.

In other words, if the use of the second addition/subtraction data produced in order mainly to shorten a response time to respond to a change from a start gray-scale level to a reaching gray-scale level is judged to cause a color gap, the first addition/subtraction data produced in order mainly to prevent production of a color gap is used to control overdrive. If the use of the second addition/subtraction data is judged not to cause a color gap, the second addition/subtraction data is used to control overdrive.

Otherwise, the first addition/subtraction data produced for each of red, green, and blue signals and the second addition/subtraction data produced for each of the red, green, and blue signals may be weighted based on color gap detection data and convoluted. The resultant data may be adopted as the third addition/subtraction data for each of the red, green, and blue signals.

In this case, when overdrive is implemented, optimal addition/subtraction data can be selected. Both prevention of production of a color gap and improvement of motion picture quality deriving from a shortened response time can be achieved.

Referring back to FIG. 5, a description will proceed. Addition/subtraction data produced by the third addition/subtraction data production circuit 520 is transferred to the data addition/subtraction circuit 522 over the data bus 521. The data addition/subtraction circuit 522 can now add or subtract correction data to or from changed display data. The timing control circuit 524 converts the resultant data into display data and sync signals based on which the signal line drive circuit 526 and scan line drive circuit 529 act. The display data and sync signals are transferred over the data buses 525 and 528.

The signal line drive circuit 526 converts the display data, which is transferred over the data bus 525, into an associated gray-scale voltage, and transmits the gray-scale voltage over the drain wire bus 527. The signal line drive circuit 526 simultaneously performs the action of converting display data into a gray-scale voltage for all pixels constituting one horizontal line. The scan line drive circuit 529 selects a line, to which gray-scale voltages are applied, at the timing when the signal line drive circuit 526 places the gray-scale voltages on the drain wire bus 527. This action is performed line by line. Consequently, gray-scale voltages represented by display data expressing one screen image are applied to the pixels, and brightness represented by the display data are attained.

An example of the configuration of the liquid crystal display device to which the present invention is adapted has been described in conjunction with FIG. 5.

Incidentally, the present embodiment has been described as an example of a liquid crystal display device in which overdrive is implemented in order to prevent an overshoot from occurring during a response to a change from one brightness to other. A description will be made of a case where overdrive is implemented in order to yield an overshoot during a response to a change of brightness.

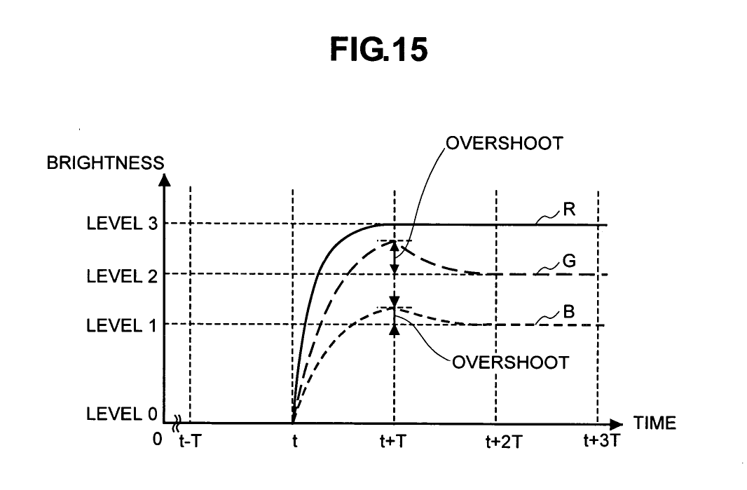

FIG. 15 shows an example of a response to a change of brightness to be made in the case where overdrive is implemented in the liquid crystal display device. The axis of ordinates indicates a gray-scale level and the axis of abscissas indicates a time.

As correction data employed in overdrive gets larger, a change from one gray-scale level to other undergoes an overshoot in the same manner as a change of a green or blue gray-scale level from one level to other does as indicated in FIG. 15.

As far as a blur in a displayed motion picture is concerned, compared with when no overshoot is yielded, when a small overshoot is yielded, the contour of an image is enhanced and the blur is discerned to be reduced. Therefore, correction data may be determined so that an overshoot will occur. However, if an overshoot is too large, a color gap is produced. The degree of an overshoot must therefore be determined appropriately.

Moreover, when correction data is determined in order to yield an overshoot, a new problem takes place. As mentioned above, for example, if a gray-scale voltage corresponding to a target gray-scale level is close to an upper or lower limit of a range of usable gray-scale voltages, overdrive cannot be implemented appropriately. Therefore, depending on a combination of red, green, and blue gray-scale levels, a certain pixel may include a sub-pixel at which a change of a gray-scale level from one level to other undergoes an overshoot and a sub-pixel at which a change of a gray-scale level from one level to other does not undergo an overshoot.

In the case shown in FIG. 15, the change of the green or blue gray-scale level from one level to other undergoes an overshoot because of overdrive, while the change of the red gray-scale level from one level to other does not undergo an overshoot. This is because the gray-scale voltage corresponding to a target red gray-scale level is close to the upper limit of the range of usable gray-scale voltages. Therefore, overdrive cannot be implemented.

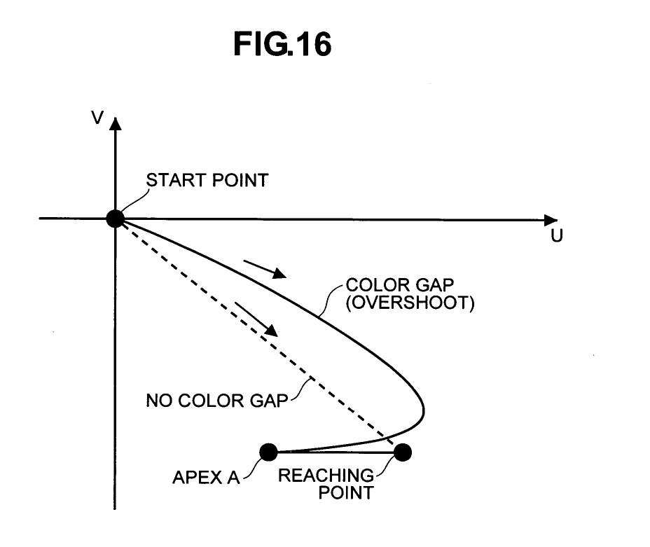

FIG. 16 shows an example of the locus of points indicating U and V signal levels into which the red, green, and blue signals representing the red, green, and blue gray-scale levels whose changes are shown in FIG. 15 are converted. As apparent from the comparison of FIG. 16 with FIG. 4, when a case where an overshoot is yielded is compared with a case where no overshoot is yielded, a change of colors occurring while a liquid crystal display is responding to a change of brightness is more complex in the case where an overshoot is yielded. In the case shown in FIG. 4 where no overshoot is yielded, the locus of points indicating U and V signal levels is a moderately curved line. In the case shown in FIG. 16 where an overshoot is yielded, the locus of points indicating U and V signal levels has an apex A, at which a radius of curvature changes abruptly, in the middle thereof. The apex A in FIG. 16 indicates brightness associated with the red, green, and blue gray-scale levels indicated at a time instant t+T in FIG. 15. Moreover, the locus of points starting with a start point in FIG. 16 and ending with a reaching point therein is equivalent to the period from a time instant t to the time instant t+T in FIG. 15. The locus of points starting with the apex A and ending with the reaching point is equivalent to the period from the time instant t+T in FIG. 15 to the instant a response is completed.

As mentioned above, when correction data is determined in order to yield an overshoot, for example, the apex A, that is, a point in the UV plane indicating brightness of a frame (at the time instant t+T) succeeding a frame (at the time instant t) in which the red, green, and blue gray-scale levels have changed is determined as a color gap detection point. Whether the color gap detection point falls within the permissible range is detected in order to check if a color gap is produced. If a color gap is produced, smaller correction data, that is, correction data produced in order to prevent production of a color gap is substituted for correction data produced to yield an overshoot. Thus, production of a color gap can be suppressed. Namely, if a color gap is large, after one frame period elapses (at the time instant t+T), brightness of a pixel is made nearly equal to brightness represented by uncorrected display data. On the other hand, if a color gap is small, after one frame period elapses (at the time instant t+T), the brightness of a pixel is made larger than the brightness represented by the uncorrected display data. In terms of a control sequence, first, correction data yielding an overshoot is used to correct display data. If a color gap is detected to fall outside a permissible range, correction data produced in order to prevent a color gap is substituted for the correction data yielding an overshoot.

As mentioned above, according to the present invention, even when correction data is produced in order to yield an overshoot, production of a color gap can be suppressed.

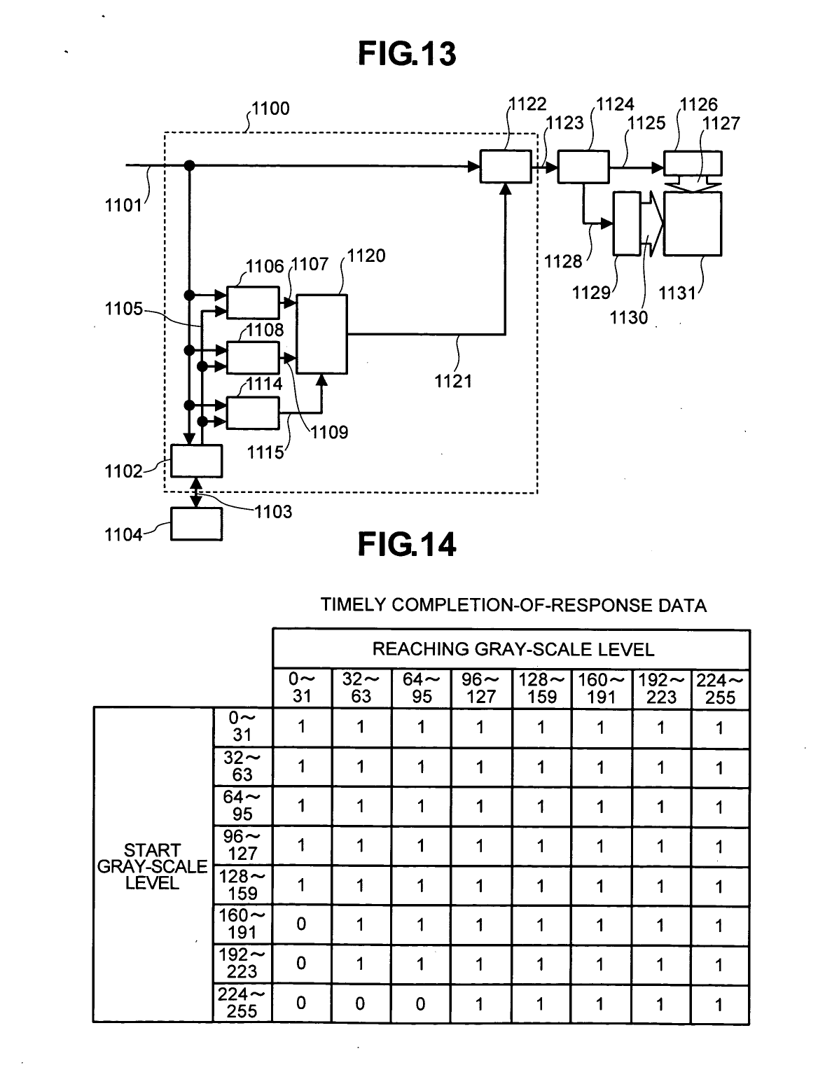

Next, referring to FIG. 13, another example of the configuration of the liquid crystal display device to which the present invention is adapted will be described below.

In FIG. 13, there are shown: a data correction circuit 1100 that implements overdrive; a bus 1101 over which display data and sync signals received from an external device are transferred; a frame memory control circuit 1102; a frame memory control bus 1103; a frame memory 1104; and a data bus 1105 over which display data read from the frame memory is transferred.

A first addition/subtraction data production circuit 1106 compares display data transferred over the data bus 1101 with display data transferred over the data bus 1105. First addition/subtraction data produced by the first addition/subtraction data production circuit 1106 is transferred over a data bus 1107.

A second addition/subtraction data production circuit 1108 compares display data transferred over the data bus 1101 with display data transferred over the data bus 1105. Second addition/subtraction data produced by the second addition/subtraction data production circuit 1108 is transferred over a data bus 1109.

A completion detection circuit 1114 compares display data transferred over the data bus 1101 with display data transferred over the data bus 1105. Timely completion-of-response data produced by the completion detection circuit 1114 is transferred over a data bus 1115.

A third addition/subtraction data production circuit 1120 produces third addition/subtraction data on the basis of the first addition/subtraction data transferred over the data bus 1107, the second addition/subtraction data transferred over the data bus 1109, and the timely completion-of-response data transferred over the data bus 1115. The third addition/subtraction data produced by the third addition/subtraction data production circuit 1120 is transferred over a data bus 1121.

A data addition/subtraction circuit 1122 converts display data transferred over the data bus 1101 according to the third addition/subtraction data transferred over the data bus 1121. Display data produced by the data addition/subtraction circuit 1122 and control signals used to control timings such as sync signals are transferred over a bus 1123.

A timing control circuit 1124 produces various kinds of timing signals for a liquid crystal drive circuit. Display data and sync signals produced by the timing control circuit 1124 are transferred over a bus 1125. The sync signals produced by the timing control circuit 1124 are transferred to a scan line drive circuit 1129 over a bus 1128.

A signal line drive circuit 1126 produces a gray-scale voltage according to display data transferred over the bus 1125. The scan line drive circuit 1129 selects a line, to which the gray-scale voltages produced by the signal line drive circuit 1126 are applied, one after another. A liquid crystal display panel 1131 has a plurality of pixels arranged in the form of a matrix.

A gray-scale voltage produced by the signal line drive circuit 1126 is transferred to the liquid crystal display panel 1131 over a drain wire bus 1127. A scan voltage produced by the scan line drive circuit 1129 is transferred to the liquid crystal display panel 1131 over a gate wire bus 1130.

In the liquid crystal display device in accordance with the present invention, display data and sync signals received from an external device over the data bus 1101 are stored in the frame memory 1104 via the frame memory control circuit 1102 over the frame memory control bus 1103. After the elapse of one frame period, the frame memory control circuit 1102 sequentially reads display data from the frame memory 1104, and transmits the display data over the data bus 1105. The frame memory control circuit 1102 repeats this action involving the frame memory control bus 1103 and frame memory 1104.

Consequently, display data received over the bus 1105 by each of the first addition/subtraction data production circuit 1106, second addition/subtraction data production circuit 1108, and completion detection circuit 1114 corresponds to display data that lags behind display data, which is transferred over the data bus 1101, by one frame period, that is, corresponds to display data that represents an immediately preceding frame. Thus, two consecutive frame data are used to calculate a change of a gray-scale level from one level to other exhibited by a pixel.

Consequently, the first addition/subtraction data production circuit 1106 can judge whether display data makes a change over successive frame periods. Furthermore, if display data makes a change over successive frame periods, first addition/subtraction data serving as correction data to be transferred over the data bus 1107 can be calculated based on the relationship between unchanged display data and changed display data.

For the calculation of the first addition/subtraction data to be transferred over the data bus 1107, a method described below may be adopted. For example, a first table from which optimal first addition/subtraction data is retrieved based on the combination of a start gray-scale level and a reaching gray-scale level is created in advance. The first addition/subtraction data is determined by referencing the table.

As for the first table, the first table shown in FIG. 6 is adopted. FIG. 13 shows an example in which an in-plane switching (IPS)-mode liquid crystal display panel is adopted as the liquid crystal display panel 1131. Once the values specified in the table are appropriately determined, the method using the table can be adapted to any liquid crystal display panel of other mode.

The first addition/subtraction data specified in the first table is determined so that nearly the same response time will respond to a change from every start gray-scale level to every reaching gray-scale level. Specifically, the response times match the longest response time to respond to the slowest change from a start gray-scale level to a reaching gray-scale level. As for the first table, the same table may be used for all red, green, and blue signals, or different tables may be used for the red, green, and blue signals respectively.

In FIG. 13, the first addition/subtraction data varies depending on a material made into the liquid crystal display panel. The method of calculating the first addition/subtraction data using the table has been described. Alternatively, a method of calculating the first addition/subtraction data by performing arithmetic operations using, for example, a start gray-scale level, a reaching gray-scale level, and some other predetermined parameters will do.

For example, the values specified in the first addition/subtraction data table may be approximated to a linear function or a quadratic function. In this case, preferably, the coefficients contained in the terms of the function can be externally designated as parameters. Consequently, the table can be flexibly adapted to various types of liquid crystal display panels. Otherwise, the values specified in the first addition/subtraction data table may be fitted to a polygonal line composed of a plurality of segments and expressed as a function. In this case, the position at which segments intersect or the slope of each segment can be externally designated as a parameter. Consequently, the table can be flexibly adapted to various types of liquid crystal display panels.

Moreover, preferably, the first table and the parameters employed in arithmetic operations can be externally designated using, for example, a storage device such as an EEPROM, an interface with a CPU, or an external terminal via which setting information is received.

Similarly, the second addition/subtraction data production circuit 1108 can judge whether display data makes a change over successive frame periods. Furthermore, if display data makes a change over successive frame periods, second addition/subtraction data serving as correction data to be transferred over the data bus 1109 can be calculated based on the relationship between unchanged display data and changed display data.

For the calculation of the second addition/subtraction data to be transferred over the data bus 1109, a method described below can be adopted. Namely, for example, a second table from which optimal second addition/subtraction data is retrieved based on the combination of a start gray-scale level and a reaching gray-scale level is created in advance. Thus, the second addition/subtraction data can be determined by referencing the table.

As the second table, the second table shown in FIG. 7 is adopted. The second addition/subtraction data is determined so that the shortest response time will response to a change from every start gray-scale level to every reaching gray-scale level. As for the second table, the same table may be used for all red, green, and blue signals, or different tables may be used for the red, green, and blue signals respectively.

In FIG. 13, for example, the signal line drive circuit 1126 associates a gray-scale level with a gray-scale voltage. The association is intended to adjust a gamma defining the relationship between red, green, and blue gray-scale levels received by the liquid crystal display device and brightness determined with the gray-scale levels. If the gamma characteristic of the liquid crystal display device is modified, the relationship between the gray-scale level and gray-scale voltage changes. Therefore, the values specified in the second table must be altered according to the modified gamma characteristic.

The second addition/subtraction data employed in the configuration shown in FIG. 13 varies depending on a material made into the liquid crystal display panel. The method of calculating second addition/subtraction data using the table has been described. Alternatively, a method of calculating the second addition/subtraction data by performing arithmetic operations using, for example, a start gray-scale level, a reaching gray-scale level, and some predetermined parameters will do.

For example, the values specified in the second addition/subtraction data table may be approximated to a linear function or a quadratic function. In this case, preferably, the coefficients contained in the terms of the function can be externally designated as parameters. Consequently, the table can be flexibly adapted to various types of display panels. Otherwise, the second addition/subtraction data table may be fitted to a polygonal line composed of a plurality of segments and expressed as a function. In this case, preferably, the position at which segments intersect or the slope of each segment can be externally designated as a parameter. Consequently, the table can be flexibly adapted to various types of display panels.

Moreover, preferably, the second table and the parameters employed in arithmetic operations can be externally designated using, for example, a storage device such as an EEPROM, an interface with a CPU, or an external terminal via which setting information is received.

Similarly, the completion detection circuit 1114 can judge whether display data makes a change over successive frame periods. If display data makes a change over successive frame periods, timely completion-of-response data to be transferred over the data bus 1115 can be calculated based on the relationship between unchanged display data and changed display data.

What is referred to as timely completion-of-response data is data indicating whether when overdrive is implemented based on the data retrieved from the second table according to the combination of a start gray-scale level and a reaching gray-scale level, the response of the liquid crystal display panel is completed within a predetermined time and target brightness is attained.

For calculation of the timely completion-of-response data to be transferred over the data bus 1115, a method described below may be adopted. For example, a table according to which whether a response is completed timely is detected based on the combination of a start gray-scale level and a reaching gray-scale level is created in advance. Whether a response is completed timely can be determined by referencing the table.

FIG. 14 shows an example of a fourth table that when overdrive is implemented using the second addition/subtraction data retrieved from the second table on the basis of the combination of a start gray-scale level and a reaching gray-scale level, is used to detect whether a response is completed within a predetermined time in order to attain target brightness. In the fourth table, 1 specified relative to combinations of the start gray-scale level and reaching gray-scale level signifies that a response to a change from the start gray-scale level to the reaching gray-scale level is completed within the predetermined time. 0 specified relative to combinations thereof specifies that a response to a change from the start gray-scale level to the reaching gray-scale level is not completed within the predetermined time.

The table shown in FIG. 14 is an example to be employed in a case where an in-plane switching (IPS)-mode liquid crystal display panel is adopted as the liquid crystal display panel 1131. Once the values specified in the table are determined appropriately, the method employing the table can be adapted to any liquid crystal display panel of other mode. As for the fourth table, the same table may be used for all red, green, and blue signals, or different tables may be used for the red, green, and blue signals respectively.

Moreover, for example, the signal line drive circuit 1126 associates a gray-scale level with a gray-scale voltage. The association is intended to adjust a gamma defining the relationship between red, green, and blue gray-scale levels received by the liquid crystal display device and brightness determined with the gray-scale levels. If the gamma characteristic of the liquid crystal display device is modified, the relationship between the gray-scale level and gray-scale voltage changes. The values specified in the fourth table must therefore be appropriately altered according to the modified gamma characteristic.

The timely completion-of-response data shown in FIG. 14 varies depending on a material made into the liquid crystal display panel. The method of detecting using the table whether a response is completed timely has been described. Alternatively, for example, a method of detecting whether a response is completed timely by performing arithmetic operations using a start gray-scale level, a reaching gray-scale level, and some predetermined parameters will do. For example, the coefficient of viscosity or elasticity exhibited by a liquid crystal material, the thickness of a liquid crystal layer of each liquid crystal cell, and the anisotropy of a dielectric constant are used as the parameters to calculate a response time.

Moreover, preferably, the values specified in the timely completion-of-response table can be externally designated using a storage device such as an EEPROM, an interface with a CPU, or an external terminal via which setting information is received.

A third addition/subtraction data production circuit 1120 produces third addition/subtraction data according to the first addition/subtraction data transferred over the data bus 1107, the second addition/subtraction data transferred over the data bus 1109, and the timely completion-of-response data transferred over the data bus 1119.

For example, assume that the timely completion-of-response data demonstrates that the use of the second addition/subtraction data brings about a pixel containing a sub-pixel whose change is responded within a predetermined time and a sub-pixel whose change is not responded within the predetermined time. In this case, the first addition/subtraction data is selected as third addition/subtraction data for correction of each of red, green, and blue signals. If the use of the second addition/subtraction data is detected not to bring about a pixel containing a sub-pixel whose change is responded within the predetermined time and a sub-pixel whose change is not responded within the predetermined time, the second addition/subtraction data is selected as third addition/subtraction data for correction of each of the red, green, and blue signals.

In other words, if the use of the second addition/subtraction data produced in order mainly to shorten a response time to respond to a change from a start gray-scale level to a reaching gray-scale level is detected to produce a color gap, overdrive is controlled in order to prevent production of the color gap. If the use of the second addition/subtraction data is detected not to produce a color gap, overdrive is controlled in order to shorten a response time.

Otherwise, the first addition/subtraction data and second addition/subtraction data calculated for correction of each of red, green, and blue signals may be weighted according to color gap detection data and then convoluted. The resultant data may be adopted as third addition/subtraction data for correction of each of the red, green, and blue signals.

Consequently, when overdrive is implemented, optimal addition/subtraction data can be selected. Both control of production of a color gap and improvement of motion picture quality deriving from a shortened response time can be achieved.

Referring back to FIG. 13, the description of actions will proceed. The third addition/subtraction data produced by the third addition/subtraction data production circuit 1120 is transferred to the data addition circuit 1122 over the data bus 1121. The data addition circuit 1122 can add or subtract correction data to or from a changed portion of display data. The timing control circuit 1124 converts the resultant data into display data and sync signals, based on which the signal line drive circuit 1126 and scan line drive circuit 1129 act, and transfers the display data and sync signals over the data buses 1125 and 1128.

The signal line drive circuit 1126 converts the display data, which is transferred over the data bus 1124, into an associated gray-scale voltage, and transmits the gray-scale voltage over the drain wire bus 1127. The signal line drive circuit 1126 repeats the action of converting display data into a gray-scale voltage for each of pixels constituting one horizontal line.

The scan line drive circuit 1129 selects a line, to which the gray-scale voltages are applied, at the timing at which the signal line drive circuit 1127 places the gray-scale voltages on the drain wire bus 1127. This action is sequentially performed line by line, whereby gray-scale voltages represented by display data expressing one screen image are applied to respective pixels. Brightness represented by the display data can be attained.

Incidentally, the first and second embodiments have been described on the assumption that the liquid crystal layers of the respective sub-pixels in the liquid crystal display device having each pixel composed of red, green, and blue sub-pixels have a uniform thickness. On the other hand, as described in, for example, Japanese Unexamined Patent Application Publication No. 5-19687, the thicknesses of the liquid crystal layers of red, green, and blue sub-pixels respectively may be optically optimized in order to minimize a leakage of light during display in black. Thus, color reproducibility and a contrast may be improved compared with when the thicknesses of the liquid crystal layers are uniform. This technology is already known. However, the thickness of a liquid crystal layer affects a response time in a liquid crystal display. If the thicknesses of the liquid crystal layers of red, green, and blue sub-pixels are not uniform, response times at the red, green, and blue sub-pixels respectively are not uniform. As mentioned previously, when the response times at the red, green, and blue sub-pixels are not uniform, a color gap is produced during a response. This results in the degraded quality of a displayed motion picture.

However, when the present invention is adapted to a liquid crystal display device in which the thicknesses of liquid crystal layers of red, green, and blue sub-pixels respectively are not uniform, correction data is determined for each display data to be written in each of the red, green, and blue sub-pixels so that the response times at the red, green, and blue sub-pixels will be agreed with one another. Consequently, production of a color gap during a response can be suppressed. A good-quality motion picture devoid of an afterimage or a blur can be displayed.

1. A display device comprising:
a display panel having a plurality of pixels arranged in a matrix;
a signal line drive circuit for applying a gray-scale voltage corresponding to display data received from an external device, to each of said pixels;
a scan line drive circuit for selecting a pixel to which the gray-scale voltage is applied; and
a correction circuit for correcting display data for a current frame period, according to a change from display data for an immediately preceding frame period to the display data for the current frame period,
wherein said correction circuit produces correction data, which is used to correct the display data for the current frame period, according to a change from the color component of the display data for the immediately preceding frame period to the color component of the display data for the current frame period.

2. A display device comprising:
a display panel having a plurality of pixels arranged in a matrix;
a signal line drive circuit for applying a gray-scale voltage corresponding to display data received from an external device, to each of said pixels;
a scan line drive circuit for selecting a pixel to which the gray-scale voltage is applied; and
a correction circuit for correcting display data for a current frame period, according to a change from display data for an immediately preceding frame period to the display data for the current frame period,
wherein said correction circuit corrects the red, green, and blue components of the display data for the current frame period respectively or all together according to a change from the color component of the display data for the immediately preceding frame period to the color component of the display data for the current frame period.

3. A display device comprising:
a display panel having a plurality of pixels arranged in a matrix;
a signal line drive circuit for applying a gray-scale voltage corresponding to display data received from an external device, to each of said pixels;
a scan line drive circuit for selecting a pixel to which the gray-scale voltage is applied; and
a correction circuit for correcting display data for a current frame period, according to a change from display data for an immediately preceding frame period to the display data for the current frame period,
wherein said correction circuit respectively produces correction data, which is used to correct the display data for the current frame period, according to a change from the color component of the display data for the immediately preceding frame period to the color component of the display data for the current frame period.

4. A display device according to claim 1, wherein said correction data to be used to correct the display data for the current frame period is produced using a table that defines the combination of a start gray-scale level and a reaching gray-scale level, or produced by performing arithmetic operations using a function.

5. A display device according to claim 1, wherein said correction circuit selects either of first correction data and second correction data as correction data, which is used to correct the display data for the current frame period, according to color gap detection data.

6. A display device according to claim 5, wherein the color gap detection data is produced based on the positional relationship among a reaching point, a start point, and a color gap detection on a graph of color coordinates.

7. A display device according to claim 6, further comprising a production circuit for producing a color gap permissible range to be used in relation to the color gap detection point.

8. A display device according to claim 7, wherein said production circuit produces the color gap permissible range by referencing a table that defines the combination of two color components.

9. A display device according to claim 1, wherein said correction circuit selects either of first correction data and second correction data as correction data, which is used to correct the display data for the current frame period, according to timely completion-of-response data.

10. A display device according to claim 9, further comprising a production circuit that produces the timely completion-of-response data by referencing a table that defines the combination of a start gray-scale level and a reaching gray-scale level.

11. A display device comprising:
a display panel having a plurality of pixels arranged in a matrix;
a signal line drive circuit for applying a gray-scale voltage corresponding to display data received from an external device, to each of said pixels;
a scan line drive circuit for selecting a pixel to which the gray-scale voltage is applied; and
a correction circuit for correcting display data a current frame for, according to a change from display data for an immediately preceding frame period to the display data for the current frame period,
wherein said correction circuit detects a color gap produced over the immediately preceding frame period and current frame period alike;
wherein if the color gap falls within a permissible range, said correction circuit uses correction data included in a first group of correction data to correct the display data for the current frame period;
wherein if the color gap falls outside the permissible range, said correction circuit uses correction data included in a second group of correction data to correct the display data for the current frame period; and
wherein when the display data not changed by the external device, brightness represented by display data corrected using the correction data included in the first group of correction data is larger than brightness represented by display data corrected using the correction data included in the second group of correction data.

12. A display device according to claim 11, wherein: brightness of each pixel corrected using each correction data included in the first group of correction data is larger than brightness value represented by the uncorrected display data for the current frame period; and brightness of each pixel corrected using each correction data included in the second group of correction data is nearly equal to brightness represented by the uncorrected display data for the current frame period.

13. A display device according to claim 11, wherein said correction circuit detects a color gap produced over the current frame period.

14. A display device according to claim 11, wherein each correction data included in the first group of correction data is larger than each correction data included in the second group of correction data.
